(19) United States
(12) Patent Application Publication
(10) Pub. No.: US 2015/0181166 A1
(43) Pub. Date: Jun. 25, 2015

(54) ELECTRONIC DEVICE AND METHOD FOR VIDEO CONFERENCE MANAGEMENT

(71) Applicant: HON HAI PRECISION INDUSTRY CO., LTD., New Taipei (TW)

(72) Inventors: MING-CHUAN KAO, New Taipei (TW); JEN-HSIUNG CHARNG, New Taipei (TW)

(21) Appl. No.: 14/559,370

(22) Filed: Dec. 3, 2014

(30) Foreign Application Priority Data
Dec. 23, 2013 (CN) 201310719989.7

(51) Int. Cl. H04N 7/15; H04L 29/08; H04N 7/14; H04L 29/06

(52) U.S. Cl. CPC H04N 7/152; H04L 65/403; H04L 67/10; H04N 7/147

(57) ABSTRACT

A method of managing video conference includes requesting the server for each IP address of each of the remote electronic devices. The server transmits an IP address of each of the remote electronic devices to a local electronic device. According to the received IP addresses, connections are established between the local electronic device and each of the remote electronic devices. An image of a user of the local electronic device is acquired. Images of remote users of the remote electronic devices sent by the remote electronic devices are received. The acquired image and the received images are merged into an image for the user of the local electronic device.

### CROSS-REFERENCE TO RELATED APPLICATIONS

This application claims priority to Chinese Patent Application No. 201310719989.7 filed on Dec. 23, 2013, the contents of which are incorporated by reference herein.

### FIELD

Embodiments of the present disclosure relate to video conference technology, and particularly to video conference management using an electronic device.

### BACKGROUND

When a server that is connected to a plurality of electronic devices is used to implement a video conference, the server may acquire images from the electronic devices and merge the acquired images into a single image. Then the server may transmit the merged image to each of the electronic devices. However, image processing procedures may need to be executed on the server.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a diagrammatic view of one embodiment of a local electronic device including an management system.

FIG. 2 is a diagrammatic view of one embodiment of function modules of the management system in the local electronic device of FIG. 1.

FIG. 3 illustrates a flowchart of one embodiment of a method for managing video conference in the local electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

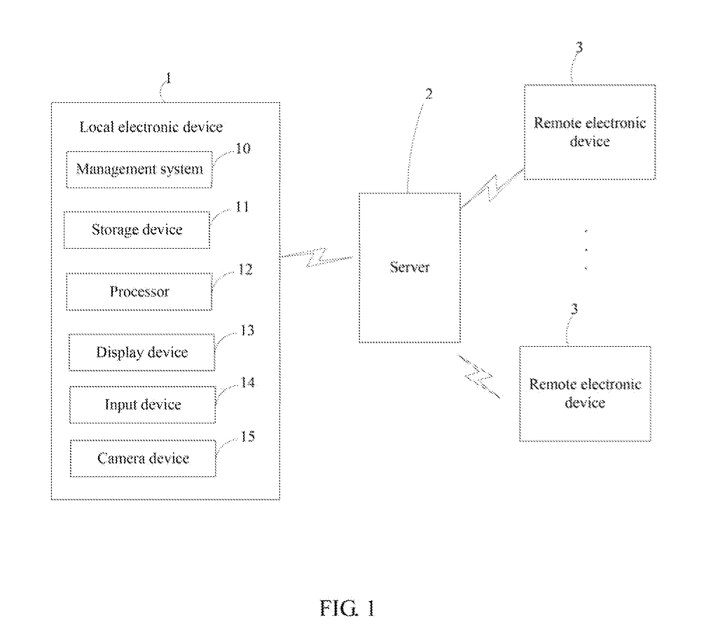

FIG. 1 illustrates a diagrammatic view of one embodiment of a local electronic device. Depending on the embodiment, a local electronic device 1 includes, but is not limited to, a management system 10, a storage device 11, at least one processor 12, a display device 13, an input device 14 and a camera device 15. The electronic device 1 can be a computer, a smart phone, a personal digital assistant (PDA), or another suitable electronic device. FIG. 1 illustrates only one example of the electronic device that can include more or fewer components than illustrated, or have a different configuration of the various components in other embodiments.

The local electronic device 1 is connected to a server 2. The server 2 is connected to a plurality of remote electronic devices 3. The server 2 stores an Internet Protocol (IP) address of the local electronic device 1 and each of the remote electronic devices 3. The remote electronic devices 3 can be computers, smart phones, personal digital assistants (PDAs), or other suitable electronic devices.

The management system 10 can establish connections between the local electronic device 1 and each of the remote electronic devices 3. Each of the remote electronic devices 3 can transmit an image of a remote user of each of the remote electronic devices to the local electronic device 1. The management system 10 can receive the images and generate a merged image for a user of the local electronic device based on the received images by combining the received images. Therefore, the management system 10 can reduce a usage of network resources.

In at least one embodiment, the storage device 11 can include various types of non-transitory computer-readable storage mediums. For example, the storage device 11 can be an internal storage system, such as a flash memory, a random access memory (RAM) for temporary storage of information, and/or a read-only memory (ROM) for permanent storage of information. The storage device 11 can also be an external storage system, such as a hard disk, a storage card, or a data storage medium. The display device 13 can display images and videos, and the input device 14 can be a mouse, a keyboard, or a touch panel.

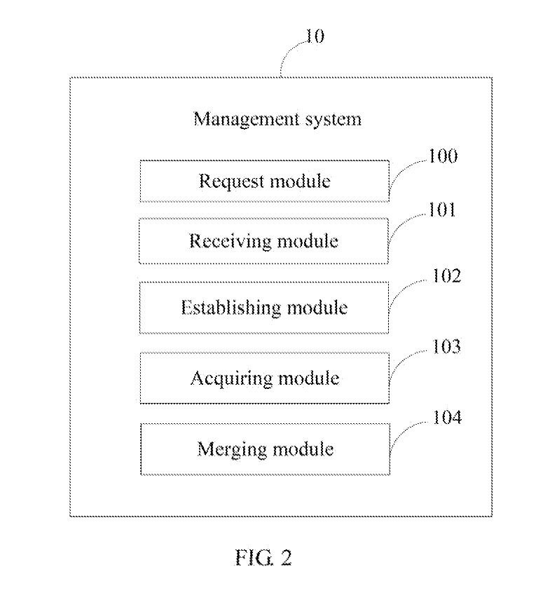

FIG. 2 is a diagrammatic view of one embodiment of function modules of the management system. In at least one embodiment, the management system 10 can include a request module 100, a receiving module 101, an establishing module 102, an acquiring module 103, and a merging module 104. The function modules 100, 101, 102, 103 and 104 can include computerized codes in the form of one or more programs, which are stored in the storage device 11. The at least one processor 12 executes the computerized codes to provide functions of the function modules 100-104.

When the user of the local electronic device 1 logs in to the management system 10, the request module 100 requests the server 2 for an Internet Protocol (IP) address of each of the remote electronic devices 3.

The server 2 transmits the IP address of each of the remote electronic devices 3 to the local electronic device 1. The receiving module 101 receives the IP address of each of the remote electronic devices 3. In at least one embodiment, the local electronic device 1 can identify each of the remote electronic devices 3 according to the IP address of each of the remote electronic devices.

The establishing module 102 establishes connections between the local electronic device 1 and each of the remote electronic devices 3 according to the received IP addresses.

In at least one embodiment, the establishing module 102 establishes the connections via a Voice over Internet Protocol(VoIP). When the establishing module 102 establishes the connections successfully, the local electronic device 1 can directly communicate with each of the remote electronic devices 3. When the establishing module 102 fails to establish the connections, the establishing module 102 re-establishes the connections.

The camera device 15 of the local electronic device 1 captures an image of a user of the local electronic device 1. The acquiring module 103 acquires the image from the camera device.

Camera devices of the remote electronic devices 3 capture images of remote users. The remote electronic devices 3 acquire the images of the remote users and transmit the images of remote users to the local electronic device 1. The receiving module 101 receives the images of the remote users from the remote electronic devices 3.

The merging module 104 merges the acquired image and the received images into a merged image for the user of the local electronic device. In at least one embodiment, The merging module 104 determines a number of the acquired image and the received images. The merging module 104 further determines resolutions of the acquired image and the received images. According to the determined number and the determined resolutions, the merging module 104 creates a two-dimensional array. The merging module 104 stores the acquired image and the received images in the two-dimensional array. Each of the acquired image and the received images is stored as an element of the two-dimensional array.

For example, in the embodiment A is a local electronic device, B and C are remote electronic devices. A receives an image labeled B1 having a resolution (720×480) from B, and receives an image labeled C1 having a resolution (720×480) from C. Therefore, images B1 and C1 are received images. An image labeled A1 having a resolution (720×480) is an acquired image of A. The merging module 104 creates a two-dimensional array with two rows and two columns. Each element of the two-dimensional array can store an image having a predetermined resolution, such as (720×480). Then the merging module 104 stores the images A1 in a first row and a first column of the two-dimensional array, stores the images B1 in a first row and a second column of the two-dimensional array, and stores the images C1 in a second row and a first column of the two-dimensional array. Then the merging module 104 displays the two-dimensional array as a merged image on the display device of local electronic device A.

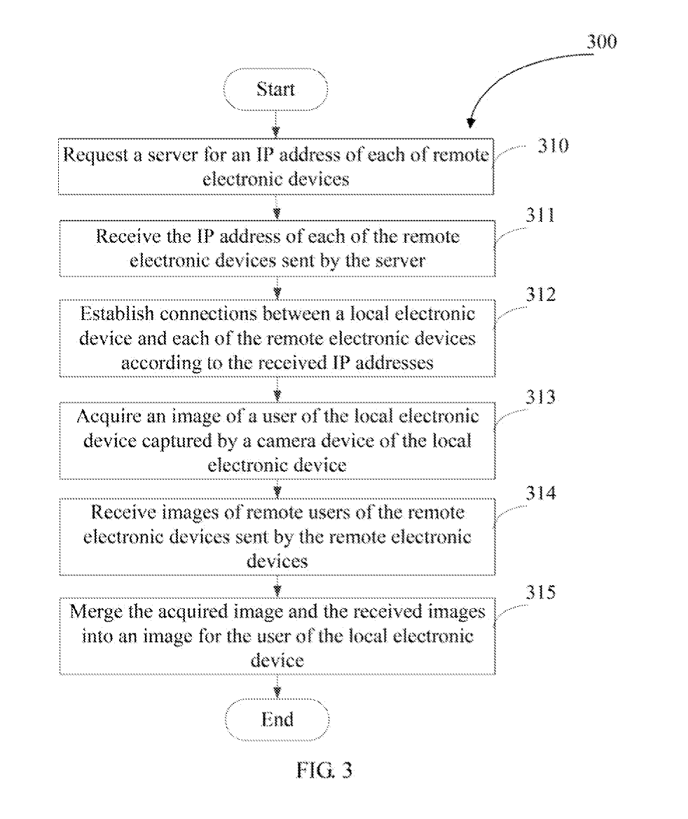

FIG. 3 illustrates a flowchart is presented in accordance with an example embodiment. The example method 300 is provided by way of example, as there are a variety of ways to carry out the method. The method 300 described below can be carried out using the configurations illustrated in FIGS. 1 and 2 for example, and various elements of these figures are referenced in explaining example method 300. Each block shown in FIG. 3 represents one or more processes, methods, or subroutines carried out in the exemplary method 300. Additionally, the illustrated order of blocks is by example only and the order of the blocks can be changed. The exemplary method 300 can begin at block 301. Depending on the embodiment, additional steps can be added, others removed, and the ordering of the steps can be changed.

At block 310, when a user of a local electronic device logs in to a management system, a request module requests a server for an Internet Protocol (IP) address of each of the remote electronic devices. The local electronic device is connected to the server. The server is connected to remote electronic devices. The server stores Internet Protocol (IP) addresses of the local electronic device and each remote electronic device.

At block 311, the server transmits the IP address of each of the remote electronic devices to the local electronic device. A receiving module receives the IP address of each of the remote electronic devices. In at least one embodiment, the local electronic device can identify each of the remote electronic devices according to the IP address of each of the remote electronic devices.

At block 312, an establishing module establishes connections between the local electronic device and each of the remote electronic devices according to the received IP addresses.

In at least one embodiment, the establishing module establishes the connections via a VoIP. When the establishing module establishes the connections successfully, the local electronic device can directly communicate with each of the remote electronic devices. When the establishing module fails to establish connections, the establishing module re-establishes the connections.

At block 313, a camera device of the local electronic device captures an image of a user of the local electronic device. An acquiring module acquires the image from the camera device.

At block 314, camera devices of the remote electronic devices capture images of remote users. The remote electronic devices acquire the images of the remote users and transmit the images of remote users to the local electronic device. The receiving module receives the images of the remote users from the remote electronic devices.

At block 315, a merging module merges the acquired image and the received images into a merged image for the user of the local electronic device. In at least one embodiment, the merging module determines a number of the acquired image and the received images. The merging module further determines the resolutions of the acquired images and the received images. According to the determined number and the determined resolutions, the merging module creates a two-dimensional array. The merging module stores the acquired image and the received images in the two-dimensional array. Each of the acquired image and the received images is stored as an element of the two-dimensional array.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for video conference management using a local electronic device, the local electronic device being connected to a server which is connected to remote electronic devices and storing Internet Protocol (IP) addresses of the local electronic device and the remote electronic device, the method comprising:
requesting the server for an IP address of each of the remote electronic devices;
receiving the IP address of each of the remote electronic devices from the server;
establishing connections between the local electronic device and each of the remote electronic devices according to the IP address of each of the remote electronic devices;
acquiring an image of a user of the local electronic device captured by a camera device of the local electronic device;
receiving images of remote users of the remote electronic devices from the remote electronic devices; and
merging the acquired image and the received images into a merged image for the user of the local electronic device.

2. The method according to claim 1, further comprising:
determining a number of the acquired image and the received images;
determining resolutions of the acquired image and the received images;
creating a two-dimensional array according to the determined number and the determined resolutions; and
storing the acquired image and the received images in the two-dimensional array, each of the acquired image and the received images being stored as an element of the two-dimensional array.

3. The method according to claim 1, wherein the local electronic device identifies each of the remote electronic device according to the received the IP addresses.

4. The method according to claim 1, wherein the connections are established between the local electronic device and each of the remote electronic devices via a Voice over Internet Protocol(VoIP).

5. A local electronic device, comprising:
a processor; and
a storage device that stores one or more programs, the local electronic device being connected to a server which is connected to remote electronic devices and storing Internet Protocol (IP) addresses of each of the local electronic device and the remote electronic device, when executed by the at least one processor, cause the at least one processor to:
request an server for an IP address of each of the remote electronic devices;
receive the IP address of each of the remote electronic devices sent from the server;
establish connections between the local electronic device and each of the remote electronic devices according to the IP address of each of the remote electronic devices;
acquire an image of a user of the local electronic device captured by a camera device of the local electronic device;
receive images of remote users of the remote electronic devices from the remote electronic devices; and
merge the acquired image and the received images into a merged image for the user of the local electronic device.

6. The local electronic device according to claim 5, wherein the at least one processor is caused to:
determine a number of the acquired image and the received images;
determine resolutions of the acquired image and the received images;
create a two-dimensional array according to the determined number and the determined resolutions; and
store the acquired image and the received images in the two-dimensional array, each of the acquired image and the received images being stored as an element of the two-dimensional array.

7. The local electronic device according to claim 5, wherein the local electronic device identifies each of the remote electronic device according to the received the IP addresses.

8. The local electronic device according to claim 5, wherein the connections are established between the local electronic device and each of the remote electronic devices via a Voice over Internet Protocol(VoIP).

9. A non-transitory storage medium having stored thereon instructions that, when executed by a processor of a local electronic device, causes the processor to perform a method for video conference management, the local electronic device being connected to a server which is connected to remote electronic devices and storing Internet Protocol (IP) addresses of each of the local electronic device and the remote electronic device, wherein the method comprises:
requesting the server for an IP address of each of the remote electronic devices;
receiving the IP address of each of the remote electronic devices sent from the server;
establishing connections between the local electronic device and each of the remote electronic devices according to the IP address of each of the remote electronic devices;
acquiring an image of a user of the local electronic device captured by a camera device of the local electronic device;
receiving images of remote users of the remote electronic devices from the remote electronic devices; and
merging the acquired image and the received images into a merged image for the user of the local electronic device.

10. The non-transitory storage medium according to claim 9, wherein the method further comprises:
determining a number of the acquired image and the received images;
determining resolutions of the acquired image and the received images;
creating a two-dimensional array according to the determined number and the determined resolutions; and
storing the acquired image and the received images in the two-dimensional array, each of the acquired image and the received images being stored as an element of the two-dimensional array.

11. The non-transitory storage medium according to claim 9, wherein the local electronic device identifies each of the remote electronic device according to the received the IP addresses.

12. The non-transitory storage medium according to claim 9, wherein the connections are established between the local electronic device and each of the remote electronic devices via a Voice over Internet Protocol(VoIP).
